(19) United States
(12) Patent Application Publication
(10) Pub. No.: US 2026/0104281 A1
(43) Pub. Date: Apr. 16, 2026

(54) ULTRASONIC FLOW SENSOR CONSTRUCTION

(71) Applicant: ElectroSea, LLC, Plymouth, MN (US)

(72) Inventors: Brian Alan GOLDEN, Eden Prairie, MN (US); Peter Samuel Broen FINZELL, Shoreview, MN (US)

(21) Appl. No.: 19/353,051

(22) Filed: Oct. 8, 2025

Related U.S. Application Data
(60) Provisional application No. 63/705,892, filed on Oct. 10, 2024.

(51) Int. Cl. G01F 1/66; G01F 1/667

(52) U.S. Cl. CPC G01F 1/662; G01F 1/667

(57) ABSTRACT

The present disclosure relates to an ultrasonic sensor unit including a sensor housing defining a flow passage. The sensor housing includes a passage wall having an inner surface defining at least a portion of the flow passage and an outer surface separated from the flow passage by a thickness of the passage wall. An ultrasonic transducer is positioned outside the flow passage for emitting ultrasonic waves that are transmitted inwardly through the thickness of the passage wall into the flow passage and for receiving ultrasonic waves that pass outwardly through the thickness of the passage wall from the flow passage. A wave transmission layer is positioned between the ultrasonic transducer and the outer surface of the passage wall. A resilient structure provides a sustained force that presses the ultrasonic transducer against the wave transmission layer.

### TECHNICAL FIELD

The disclosure also relates to flow sensors and constructions for flow sensor such as constructions for ultrasonic flow meters.

### BACKGROUND

Ultrasonic flow meters use piezoelectric transducers such as piezoceramic discs for emitting and receiving ultrasonic waves. Ultrasonic flow meters can include different types such as Doppler flow meters and transit time flow meters. There is a need for ultrasonic flow meters having robust and durable constructions particularly suited for harsh environments.

### SUMMARY

The present disclosure relates to an ultrasonic sensor unit having a robust construction adapted to for effective use and longevity in harsh environments.

The present disclosure also relates to an ultrasonic sensor unit including a sensor housing defining a flow passage. The sensor housing includes a passage wall having an inner surface defining at least a portion of the flow passage and an outer surface separated from the flow passage by a thickness of the passage wall. An ultrasonic transducer is positioned outside the flow passage for emitting ultrasonic waves that are transmitted inwardly through the thickness of the passage wall into the flow passage and for receiving ultrasonic waves that pass outwardly through the thickness of the passage wall from the flow passage. A wave transmission layer is positioned between the ultrasonic transducer and the outer surface of the passage wall. A resilient structure forces the ultrasonic transducer against the wave transmission layer.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples described herein are based.

### BRIEF DESCRIPTION OF THE DRAWINGS

The accompanying drawings, which are incorporated in and constitute a part of the specification, illustrate aspects of the present disclosure and together with the description, serve to explain the principles of the disclosure. A brief description of the drawings is as follows:

FIG. 1 is an exploded view of an ultrasonic sensor unit in accordance with the principles of the present disclosure for use in sensing flow;

FIG. 2 is a side view of a sensor housing of the ultrasonic senor unit of FIG. 1;

FIG. 3 is a top view of the sensor housing with a cover, circuit board and potting of the ultrasonic sensor unit not depicted;

FIG. 4 is a cross-sectional view taken along section line 4-4 of FIG. 2; and

FIG. 5 is a cross-sectional view taken along section line 5-5 of FIG. 3 with the cover and circuit board depicted.

### DETAILED DESCRIPTION

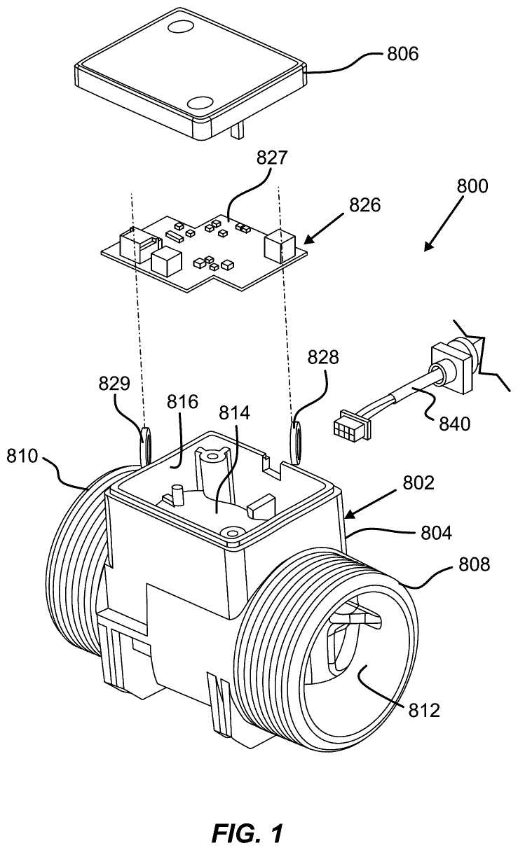

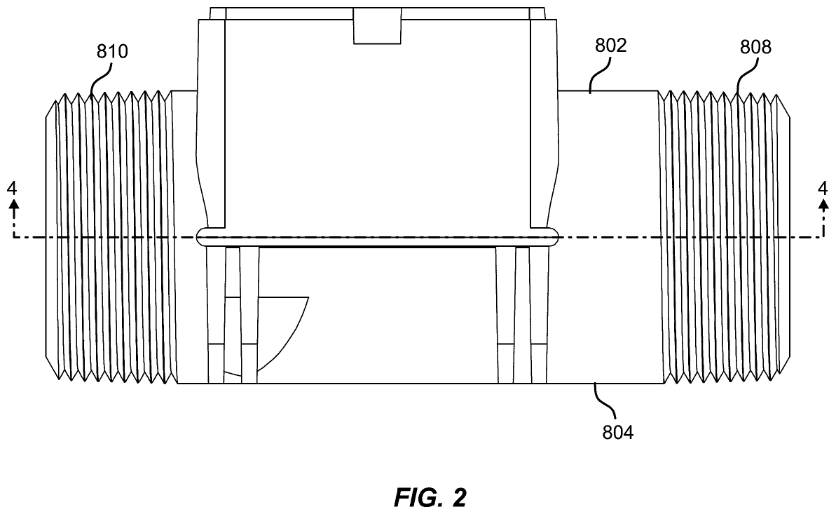

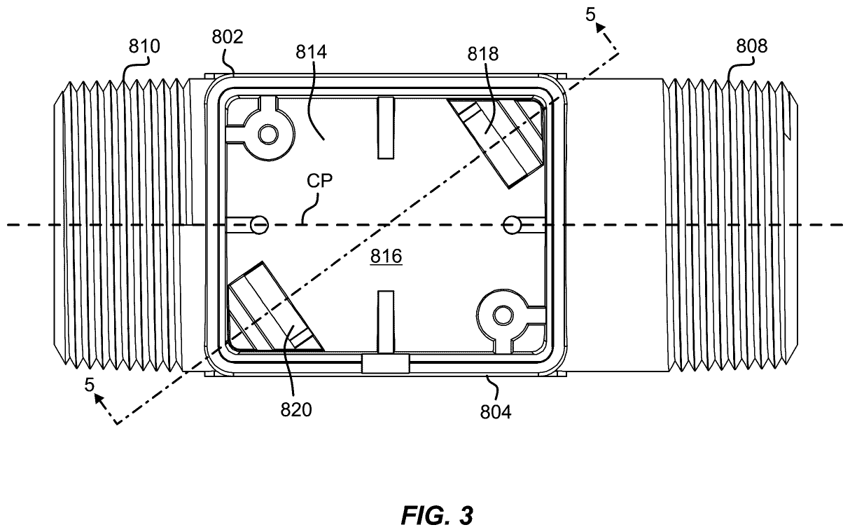

FIGS. 1-5 depict an example ultrasonic sensor unit 800 in accordance with the principles of the present disclosure. The ultrasonic sensor unit 800 is adapted for sensing flow information (e.g., flow velocity, volumetric flow rate, flow direction, etc.) within fluid (e.g., liquid) conveyance systems. It will be appreciated that the ultrasonic sensor unit 800 has a robust configuration that allows the sensor unit to be used for sensing the flow of corrosive fluids (e.g., sea water, brackish water, brine, industrial liquids, waste-water, caustic liquids, corrosive liquids, solvents, mining liquids, electroplating liquids, semi-conductor processing liquids, acids (e.g., Citric Acid, Hydrochloric Acid, etc.), alcohols (e.g., Isopropyl, Methyl, etc.) cleaning solutions, plating solutions, etc.). It will be appreciated that the fluid being sensed (e.g., metered) is adapted to flow though the ultrasonic sensor unit 800.

The ultrasonic sensor unit 800 includes a sensor housing 802 including a molded main body 804 and a cover 806. The molded main body 804 and the cover 806 can be manufactured of a polymeric material. Example polymeric materials include polycarbonate and polyamide. In certain examples, the polymeric material is glass fiber reinforced polymeric material.

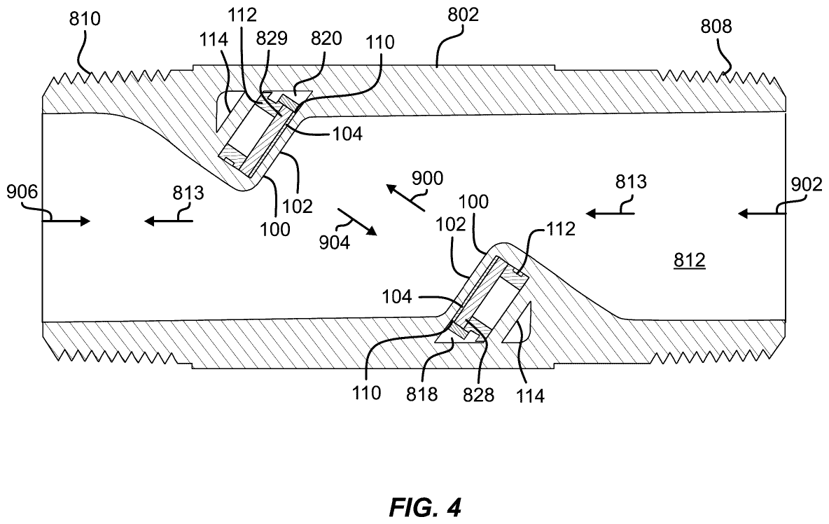

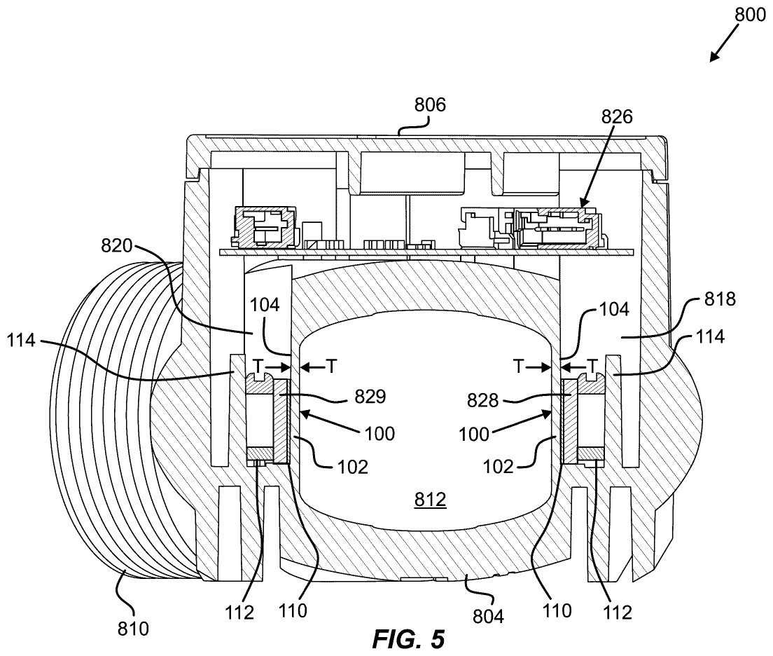

The molded body 804 includes a first fitting 808, a second fitting 810 and a flow passage 812 that extends through the molded body 804 between the first and second fittings 808, 810. Fittings 808, 810 allow the sensor housing to be connected in-line within a fluid conveyance system such that fluid (e.g., liquid) conveyed by the fluid conveyance system flows through the flow passage 812. The molded body 804 also includes a control chamber 814 separated from the flow passage 812. The control chamber 814 includes a main region 816 and first and second pockets 818, 820. The first and second sensor pockets 818, 820 are fluidly isolated from the flow passage 812 by the molded body 804. As shown at FIGS. 4 and 5, the first and second pockets 818, 820 are located on opposite sides of the flow passage 812 with the first and second pockets 818, 820 being located upstream/downstream from one another with respect to a flow direction 813 of flow through the flow passage 812. The first and second pockets 818, 820 are located opposite from one another along a diagonal plane (e.g., cross-section plane 5-5) that intersects a central reference plane CP of the flow passage at an oblique angle.

Referring to FIGS. 1 and 5, an electronic controller 826 is positioned within the main region 816 of the control chamber 814. The electronic controller 826 can include a circuit board 827 on which one or more electronic processors can be mounted. The electronic controller can be capable of accessing memory and processing data. The controller 826 can also be capable of sending and receiving signals to and from corresponding first and second ultrasonic transducers 828, 829. In certain examples, the electronic controller can include a programmable logic controller, one or more microprocessors, or like structures. The controller can include digital or analog processing capabilities and can interface with memory (e.g., random access memory, read-only memory, or other data storage). The controller can run algorithms including formulas or empirical data used to generate flow-related information (e.g., velocity, volumetric flow rate) based on sensed readings generated by the ultrasonic transducers 828, 829. In one example, the ultrasonic transducers 828, 829 are piezo-electric transducers including piezo-electric crystals. In one example, the ultrasonic transducers 828, 829 are discs such as piezoceramic discs.

The first and second ultrasonic transducers 828, 829 are respectively positioned in the first and second pockets 818, 820. The first and second ultrasonic transducers 828, 829 are adapted to generate and receive ultrasonic signals transferred through fluid (e.g., liquid) flowing through the flow passage 812. The controller 826 is adapted to interface with the first and second ultrasonic transducers 828, 829 to control generation of the ultrasonic signals and to monitor receipt of the ultrasonic signals for use in determining flow velocity within flow passage 812 by differential time methodology using a corresponding algorithm. The controller can calculate volumetric flow rate based on the sensed flow velocity and the cross-sectional area of the flow path 812.

In one example, the first fitting 808 represents a flow input side of the sensor unit 800 and the second fitting 810 represents a flow output side of the sensor unit 800. In certain examples, the first and second fittings 808, 810 can be threaded. As depicted, the first and second fittings 808, 810 include outer threads, but in other examples could include inner threads.

It will be appreciated that by separating the flow passage 812 from the control chamber 814 the material of the molded main body 804 protects the ultrasonic transducers 828, 829 and the electronic controller 826 from the corrosive effects of the liquid flowing through the flow passage 812. In certain examples the ultrasonic transducers 828, 829 can be positioned within compartments that are separate from the control board. In certain examples, potting material such as epoxy can be used to fill the control chamber 814 around the ultrasonic transducers 828, 829 and the electronic controller 826 to provide sealing of the control chamber 814. After the potting material has been applied within the control chamber 814, an access opening of the control chamber 814 can be covered by the cover 806. A control cable 840 can be routed into the control chamber 814 prior to potting of the various components and can be electrically connected to the controller to provide power and to provide the transfer of data and control signals to and from the controller 826.

Data from the ultrasonic transducers 828, 829 can be used to determine an average velocity of the water flowing through the flow passage 812 of the housing 802 using differential time methodology such that the ultrasonic sensor unit can function as a transit time meter. For example, the first transducer 828 can be excited (e.g., excited at 1 to 2 megahertz) to generate first ultrasonic signals 900 (e.g., sinusoidal pulses) that travel through the flow passage 812 in a first direction 902 (e.g., a downstream direction) and act on the second transducer 829 causing the second transducer 829 to generate first electrical signals representative of the first ultrasonic signals 900. The first electrical signals are captured using an analog to digital converter and saved in memory. Similarly, the second transducer 829 can be excited (e.g., excited at 1 to 2 megahertz) to generate second ultrasonic signals 904 (e.g., sinusoidal pulses) that travel through the flow passage 812 in a second direction 906 (e.g., an upstream direction) and act on the first transducer 828 causing the first transducer 828 to generate second electrical signals representative of the second ultrasonic signals 904. The second electrical signals are captured using the analog to digital converter and saved in memory. It will be appreciated that since the first signals 900 travel with the flowing water and the second signals 904 travel against the flowing water, the first signals 900 have a higher velocity than the second signals 904. For this reason, the first signals 900 have a shorter travel time (i.e., flight time) from the first transducer 828 to the second transducer 829 as compared to the travel time of the second signals 904 from the second transducer 829 to the first transducer 828. Based on the difference in travel time between the first and second signals 900, 904, an average velocity of the water flowing through the flow passage can be determined. Once the average velocity is determined, the volumetric flow rate can be determined based on the cross-sectional area of the flow passage 812.

Referring to FIGS. 4 and 5, for each of the pockets 818, 820 the sensor housing 802 includes a passage wall 100 having an inner surface 102 defining at least a portion of the flow passage 812 and an outer surface 104 separated from the flow passage 812 by a thickness T of the passage wall 100. The ultrasonic transducers 828, 829 are positioned outside the flow passage 812 and are arranged for emitting ultrasonic waves (e.g., signals 900, 904) that are transmitted inwardly through thickness T of the passage wall 100 into the flow passage 812 and for receiving ultrasonic waves (e.g., signals 904, 900) that pass outwardly through the thickness T of the passage wall 100 from the flow passage 812. A wave transmission layer 110 is positioned between the ultrasonic transducers 828, 829 and the outer surfaces 104 of the passage walls 100. Resilient structures 112 are provided in the pockets 818, 820 for forcing the ultrasonic transducers 828, 829 against the wave transmission layers 110. A resilient structure is a structure capable of applying a sustained force that presses an ultrasonic sensor against the transmission layer. A resilient structure is capable of absorbing and storing energy when mechanically deformed and releasing the energy upon unloading. In certain examples, the resilient structures have elastic or elastomeric characteristics. Example resilient structures include springs (e.g., metal springs such as coil springs or leaf springs) or elastomeric members (e.g., grommets) that may include materials such as such as natural rubber or synthetic rubber. Example elastomeric materials include silicone rubber, nitrile rubber, butyl rubber, polyurethane, polybutadiene, polychloroprene, ethylene propylene diene monomer, styrene butadiene rubber, fluoroelastomers, polyvinyl chloride and others. The elastomeric materials of the resilient structures can have a hardness in a range of 0-100 Shore A, 25-75 Shore A, or about 50 Shore A.

The wave transmission layer 110 is disposed between the ultrasonic transducers 828, 829 and the outer surface of the passage walls 104. The wave transmission layer can be inert. The wave transmission layer can be non-curing. The wave transmission layer can be non-reactive. The wave transmission layer can be non-adhesive. Absent the resilient structures 112, the wave transmission layer is non-adhesive in that it tends not to cure or permanently adhere the ultrasonic transducers 828, 829 to the outer surface of the passage walls 104. A non-adhesive material can have a shear strength of less than 20 pounds per square inch. Previous attempts using an adhesive as a wave transmission layer occasionally failed when adhesive cured, cracked and allowed ultrasonic transducers to separate from or at least partially lose contact with outer surface of the passage walls.

The wave transmission layer 110 can be a surface control additive or a thermal paste. In some cases, the wave transmission layer is a surface control additive. As used herein, a surface control additive is a substance that can improve slip and reduce friction between surfaces. The surface control additive can be inert. The surface control additive can be non-curing. The surface control additive can be non-reactive. The surface control additive can be non-adhesive.

The surface control additive can be a modified polysiloxane (modified silicone), polyacrylate, or perfluoro surfactant. The modified polysiloxane can be a polyether siloxane copolymer, polyester modified polysiloxane, or alkyl-modified polysiloxane. Polyester-modified siloxanes can exhibit a high stability against thermal degradation and provide long-term slip and water-repellency. Homo- and co-polymers based on (meth)acrylic monomers can be used as polyacrylate surface control additives.

The surface control additive can be a modified polysiloxane fluid. Modified polysiloxanes fluids can be modified by polyethers, polyesters, or alkyl side groups. Modification parameters include silicone content, molecular weight, and modification degree. The surface control additive can be a nonreactive modified polysiloxane fluid. The surface control additive can be an inert modified polysiloxane fluid. The surface control additive can be a non-adhesive modified polysiloxane fluid. Siloxanes are molecules that contain Si—O—Si linkages. Unmodified poly(dimethylsiloxanes) comprise a flexible backbone of repeating —Si(CH₃)₂—O— units that is highly methylated and extremely flexible. This enables a high level of surface activity because the surface energy of a methyl-saturated surface is −20 mN/m (˜20 dyne/cm). Surface tension can be measured using ASTM D1331.

The surface control additive can be a polyether siloxane copolymer. In some cases, the polyether siloxane copolymer is any appropriate polyether siloxane copolymer known in the art, for example, as disclosed in U.S. Pat. No. 3,280,160, 4,309,508, 4,814,409, 4,962,218, 5,525,640, or 7,754,778. In some cases, the polyether siloxane copolymer is commercially available. Polyether siloxane copolymers surface control additives are commercially available, for example, as TEGO® Glide 100, 410, 432, 450, or 496 from EVONIK Resource Efficiency GmbH, Essen, Germany. In some cases, the polyether siloxane copolymer has an active matter content of 100%. The polyether siloxane copolymer can have a linear structure, a comb structure, or a branched structure. The polyether siloxane copolymer can have a comb structure according to Formula (I):

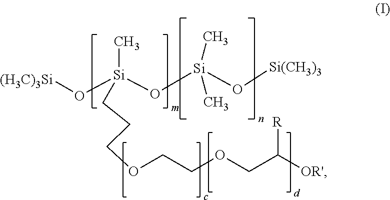

The polyether siloxane copolymer can have a linear structure according to Formula (II):

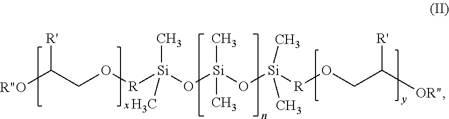

Each R′ and R″ can be independently selected from H, C₁₋₆, CH₃, or CH₂CH₃. Each R can be CH₂, CH₂CH₂, or CH₂CH₂CH₂. Each x and y can be independently selected from 0-30, 1-20, or 4-15. Each n can be in a range of 1-100, 2-70, or 50-70.

Each m can be in a range of 1-30, 2-25, or 4-15. In some cases, m+n≤10 or ≤5.

Each c and d can be independently selected from 0-30, 5-30, or 15-25. In some cases, d>c. The polyether siloxane copolymer can have a molecular weight between 1,000-30,000 g/mol, or 4,000-20,000 g/mol. The molecular weight can be an average molecular weight. The average molecular weight can be a number average molecular weight. The polyether siloxane copolymer can be inert. The polyether siloxane copolymer can be non-reactive. The polyether siloxane copolymer can be non-curing. The polyether siloxane copolymer can be non-adhesive. The polyether siloxane copolymer can have a kinematic viscosity (25 deg C.) in a range of 19-4,000 mm2/s, 20-1,600 mm2/s, or 30-1,500 mm2/s. Viscosity can be measured by ASTM D445-24.

For a drop of liquid to spread across the surface of a solid (wet the surface) work occurs to change the shape of the liquid drop. Surface tension is the work per unit area to reshape the liquid measured in dynes/cm. For example, polydimethylsiloxanes have a surface tension of about 20 dynes/cm. Hill, R. M. “Siloxane Surfactants”, Ch. 6, Specialist Surfactants, Robb, I. D. (Ed.), Chapman & Hall, 143-168, 1997. Surface tension can be measured using ASTM D1331-20 standard test methods for measurement of surface tension and interfacial tension of solutions of paints, solvents, solutions of surface-active agents and related materials. Method A measures surface tension by du Nouy ring. Method B measures interfacial tension by du Nouy ring. Method C measures surface tension by Wilhelmy plate. Method D measures interfacial tension by Wilhelmy plate. In some cases, the ASTM D1331 may be ASTM D1331-20 or ASTM D1331-20R24. The polyether siloxane copolymer can have a surface tension in a range of 20-31 mN/m, or 20-24 mN/m under ASTM D1331-20R24.

The wave transmission layer can be a thermal paste. A thermal paste is a thermally conductive substance that improves heat transfer between two surfaces. The thermal paste can be non-adhesive. The thermal past can be non-reactive. The thermal paste can be inert. The thermal past can be non-curing. The thermal paste can be electrically insulating. The thermal paste can be a silicone oil-based, synthetic oil-based, or ester-based thermal paste. The thermal paste can comprise metal oxide fillers. The thermal paste can be an ester-based non-silicone thermal paste with metal oxide fillers. The thermal paste can be a silicone oil-based thermal paste with metal oxide fillers. The thermal paste can be a synthetic oil-based thermal paste with metal oxide fillers. The metal oxide fillers can be present in a range of from 50-80 wt %, 60-70 wt %, or about 65 wt %. The metal oxide fillers can comprise zinc oxide, aluminum oxide, boron nitride, and aluminum nitride. In some cases, the thermal paste comprises a synthetic oil selected from polyalphaolefin (PAO), diester, polyol ester, polyglycol, and phosphate ester. Thermal pastes are commercially available. In some cases, the ester-based thermal paste can be Wakefield-Vette 126 series ester-based paste with metal oxides. In some cases, the synthetic-oil based thermal paste can be Super Thermal Grease II 8616 from MG Chemicals. In some cases, the thermal paste can be a silicone-based thermal paste comprising metal oxides. In some cases, the silicone-based thermal paste is 860 Heat transfer compound, MG Chemicals. In some cases, the thermal paste exhibits a thermal conductivity at 25 deg C. of >0.40 W/m-K, or >0.50 W/m-K. In some cases, the thermal paste exhibits a thermal conductivity in a range of 0.5 to 8.0 W/(m*K), 0.5 to 6.0 W/(m*K), or 0.5 to 4.0 W/(m*K). In some cases, the thermal conductivity at 25 deg C. can be ˜0.7 W/(m*K) to ˜2.0 W/(m*K). In some cases, the thermal paste exhibits an evaporation loss over 24 h at 200 deg C. of 0.6 wt % max. In some cases, evaporation loss over 22 h at 165 deg C. is 0.1 wt % max. The thermal paste can exhibit an oil bleed out at 24 h at 200 deg C. of 0.09% maximum. The thermal paste can be electrically insulating and exhibit a resistivity in a range of 1×10¹¹ ohms-cm to 2×10¹⁵ ohms·cm, or 1.8×10¹¹ ohms-cm to 1.5×10¹⁵ ohms-cm; or about 1.8×10¹¹ ohms-cm, about 2.3×10¹² ohms-cm, or about 1.5×10¹⁵ ohms-cm. The thermal paste can exhibits a dynamic viscosity in a range of 220 Pa·s to 700 Pa·s, or 365 Pa·s to 490 Pa·s. In some cases, the thermal paste exhibits a density of 2.4 g/mL to 2.7 g/mL. Thermal Conductivity may be measured using hot disc method ISO22007-2:2015. The thermal conductivity can be measured using a hot plate transient plane heat source (hot disc) method with a ThermTest TPS2500. Surface resistivity, volume resistivity may be measured under ASTM D257, IEC 62631-3-1, electrical conductivity can be measured according to ASTM D257 and D4496. Dynamic viscosity can be measured under ASTM D7042-21a.

The ultrasonic transducers 828, 829, the wave transmission layers 110 and the resilient structures 112 are positioned within the pockets 818, 820. Each of the pockets 818, 820 includes a retention wall 114 positioned opposite from and spaced apart from the outer surface 104 of a corresponding one of the passage walls 100. The ultrasonic transducers 828, 829, the wave transmission layers 110 and the resilient structures 112 are compressed within the pockets 818, 820 between the outer surfaces 104 of the passage walls 100 and the retention walls 114. Compression is provided by the elastic/elastomeric construction of the resilient structures 112.

Uses and control strategies for sensors in accordance with the principles of the present disclosure are disclosed by US Patent Publication No. US2022/0064032, which is hereby incorporated by reference in its entirety.

The various examples described above are provided by way of illustration only and should not be construed to limit the scope of the present disclosure. Those skilled in the art will readily recognize various modifications and changes that may be made with respect to the examples illustrated and described herein without departing from the true spirit and scope of the present disclosure.

1. An ultrasonic sensor unit comprising:
a sensor housing defining a flow passage, the sensor housing including a passage wall having an inner surface defining at least a portion of the flow passage and an outer surface separated from the flow passage by a thickness of the passage wall;
an ultrasonic transducer positioned outside the flow passage for emitting ultrasonic waves that are transmitted inwardly through the thickness of the passage wall into the flow passage and for receiving ultrasonic waves that pass outwardly through the thickness of the passage wall from the flow passage;
a wave transmission layer positioned between the ultrasonic transducer and the outer surface of the passage wall; and
a resilient structure that forces the ultrasonic transducer against the wave transmission layer.

2. The ultrasonic sensor unit of claim 1, wherein the ultrasonic transducer is a piezoelectric transducer.

3. The ultrasonic sensor unit of claim 2, wherein the piezoelectric transducer is a piezoceramic disc.

4. The ultrasonic sensor unit of claim 1, wherein the sensor housing defines a pocket, wherein the ultrasonic transducer, the wave transmission layer and the resilient structure are positioned within the pocket, wherein the pocket includes a retention wall, and where the ultrasonic transducer, the wave transmission layer and the resilient structure are compressed within the pocket between the outer surface of the passage wall and the retention wall.

5. The ultrasonic sensor unit of claim 1, wherein the wave transmission layer is non-adhesive.

6. The ultrasonic sensor unit of claim 1, wherein the wave transmission layer is a surface control additive or a thermal paste.

7. The ultrasonic sensor unit of claim 6, wherein the surface control additive is a modified polysiloxane, polyacrylate, or perfluoro surfactant.

8. The ultrasonic sensor unit of claim 7, wherein the modified polysiloxane is a polyether siloxane copolymer, polyester modified polysiloxane, or alkyl-modified polysiloxane.

9. The ultrasonic sensor unit of claim 8, wherein the polyether siloxane copolymer comprises a linear structure, a comb structure, or a branched structure.

10. The ultrasonic sensor unit of claim 6, wherein the surface control additive exhibits a molecular weight between 1,000-30,000 g/mol, or 4,000-20,000 g/mol.

11. The ultrasonic sensor unit of claim 6, wherein the surface control additive exhibits a kinematic viscosity at 25 deg C. in a range of 19-4,000 mm2/s, 20-1,600 mm2/s, or 30-1,500 mm2/s by ASTM D445-24.

12. The ultrasonic sensor unit of claim 1, wherein the wave transmission layer is a thermal paste.

13. The ultrasonic sensor unit of claim 12, wherein the thermal paste exhibits a thermal conductivity at 25 deg C. in a range of 0.5 to 8.0 W/(m*K), 0.5 to 6.0 W/(m*K), or 0.5 to 4.0 W/(m*K) using hot disc method under ISO22007-2:2015.

14. The ultrasonic sensor unit of claim 12, wherein the thermal paste exhibits a dynamic viscosity of in a range of 220 Pa·s to 700 Pa·s, or 365 Pa·s to 490 Pa·s by ASTM D7042-21a.

15. The ultrasonic sensor unit of claim 12, wherein the thermal paste is a silicone oil-based, synthetic oil-based, or ester-based thermal paste, comprising metal oxides.

16. The ultrasonic sensor unit of claim 15, wherein the thermal paste comprises metal oxides selected from the group consisting of zinc oxide, aluminum oxide, boron nitride, and aluminum nitride.

17. The ultrasonic sensor unit of claim 15, wherein the thermal paste comprises the metal oxides in a range of from 50-80 wt %, or 60-70 wt % compared to the weight of the thermal paste.

18. An ultrasonic sensor unit comprising:
a sensor housing defining a flow passage, the sensor housing including a passage wall having an inner surface defining at least a portion of the flow passage and an outer surface separated from the flow passage by a thickness of the passage wall;
an ultrasonic transducer positioned outside the flow passage for emitting ultrasonic waves that are transmitted inwardly through the thickness of the passage wall into the flow passage and for receiving ultrasonic waves that pass outwardly through the thickness of the passage wall from the flow passage; and
a non-adhesive wave transmission layer positioned between the ultrasonic transducer and the outer surface of the passage wall.

19. The ultrasonic sensor unit of claim 18, wherein the ultrasonic transducer is a piezoelectric transducer.

20. The ultrasonic sensor unit of claim 18, wherein the wave transmission layer is a surface control additive or a thermal paste.
